(19) United States
(12) Patent Application Publication
(10) Pub. No.: US 2023/0269647 A1
(43) Pub. Date: Aug. 24, 2023

(54) Control Plane Aspects of Dual Active Protocol Stack Handover Report

(71) Applicant: Telefonaktiebolaget LM Ericsson (PUBL), Stockholm (SE)

(72) Inventors: Pradeepa Ramachandra, LINKÖPING (SE); Icaro Leonardo Da Silva, SOLNA (SE); Marco Belleschi, SOLNA (SE); Angelo Centonza, TORRENUEVA COSTA Granada (ES); Roman Zhohov, Linköping (SE)

(21) Appl. No.: 18/040,238

(22) PCT Filed: Jun. 29, 2021
(86) PCT No.: PCT/SE2021/050649

§ 371 Date: Feb. 1, 2023

Related U.S. Application Data
(60) Provisional application No. 63/062,396, filed on Aug. 6, 2020.

(51) Int. Cl. H04W 36/18; H04W 36/30; H04W 36/00

(52) U.S. Cl. CPC H04W 36/18; H04W 36/305; H04W 36/0079

(57) ABSTRACT

A method performed by a wireless device includes declaring a radio link failure (RLF) in a source cell of a source network node during a dual active protocol stack handover (DAPS HO) from the source cell of the source network node to a target cell of a target network node. The wireless device stores information associated with the DAPS HO and information associated with the RLF. The wireless device transmits the information to an access node.

### TECHNICAL FIELD

The present disclosure relates, in general, to wireless communications and, more particularly, systems and methods relating to control plane aspects of Dual Active Protocol Stack (DAPS) Handover Report.

### BACKGROUND

A simplified 3^{rd} Generation Partnership Project (3GPP) wireless communication system is illustrated in FIG. 1 and includes a user equipment (UE), which communicates with one or multiple access nodes, which in turn is connected to a network node. The access nodes are part of the radio access network.

For wireless communication systems pursuant to 3GPP Evolved Packet System (EPS) (also referred to as Long Term Evolution (LTE) or 4^{th} Generation (4G)) standard specifications, such as specified in 3GPP TS 36.300 v.16.2.0 and related specifications, the access nodes corresponds typically to an Evolved NodeB (eNB) and the network node corresponds typically to either a Mobility Management Entity (MME) and/or a Serving Gateway (SGW). The eNB is part of the radio access network, which in this case is the Evolved Universal Terrestrial Radio Access Network (E-UTRAN), while the MME and SGW are both part of the Evolved Packet Core network (EPC). The eNBs are inter-connected via the X2 interface, and connected to EPC via the S1 interface, more specifically via S1-C to the MME and S1-U to the SGW.

For wireless communication systems pursuant to 3GPP 5G System (5GS) (also referred to as New Radio (NR) or 5^{th} Generation (5G)) standard specifications, such as specified in 3GPP TS 38.300 v. 16.2.0 and related specifications, on the other hand, the access nodes corresponds typically to an 5G NodeB (gNB) and the network node corresponds typically to either a Access and Mobility Management Function (AMF) and/or a User Plane Function (UPF). The gNB is part of the radio access network, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs can also be connected to the 5GC via NG-U/NG-C and support the Xn interface. An eNB connected to 5GC is called a next generation eNB (ng-eNB) and is considered part of the Next Generation-Radio Access Network (NG-RAN). LTE connected to 5GC will not be discussed further in this document; however, it should be noted that most of the solutions/features described for LTE and NR in this document also apply to LTE connected to 5GC. As used herein, the term LTE is used without further specification to refer to LTE-EPC.

### Mobility in RRC_CONNECTED in LTE and NR

Mobility in RRC_CONNECTED state is also known as handover. The purpose of handover is to move the UE, due to for example, mobility, from a source access node using a source radio connection (also known as source cell connection), to a target access node, using a target radio connection (also known as target cell connection). The source radio connection is associated with a source cell controlled by the source access node. The target radio connection is associated with a target cell controlled by the target access node. So in other words, during a handover, the UE moves from the source cell to a target cell. Sometimes the source access node or the source cell is referred to as the “source”, and the target access node or the target cell is sometimes referred to as the “target”.

In some cases, the source access node and target access node are different nodes, such as different eNBs or gNBs. These cases are also referred to as inter-node handover, inter-eNB handover or inter-gNB handover. In other cases, the source access node and target access node are the same node, such as the same eNB and gNB. These cases are also referred to as intra-node handover, intra-eNB handover or intra-gNB handover and covers the case then source and target cells are controlled by the same access node. In yet other cases, handover is performed within the same cell (and thus also within the same access node controlling that cell)—these cases are also referred to as intra-cell handover.

It should therefore be understood that the source access node and target access node refers to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An RRC_CONNECTED UE in E-UTRAN or NG-RAN can be configured by the network to perform measurements of serving and neighbor cells and based on the measurement reports sent by the UE, the network may decide to perform a handover of the UE to a neighbor cell. The network then sends a Handover Command message to the UE. In LTE, this message is an RRConnectionReconfiguration message with a field called mobilityControlInfo. In NR, this message is an RRCReconfiguration message with a reconfigurationWithSync field.

These reconfigurations are actually prepared by the target access node upon a request from the source access node (over X2 or S1 interface in case of EUTRA-EPC or Xn or NG interface in case of NG-RAN-5GC) and takes into account the existing RRC configuration and UE capabilities as provided in the request from the source access node and its own capabilities and resource situation in the intended target cell and target access node. The reconfiguration parameters provided by the target access node contains, for example, information needed by the UE to access the target access node such as, for example, random access configuration, a new C-RNTI assigned by the target access node and security parameters enabling the UE to calculate new security keys associated to the target access node so the UE can send a Handover Complete message (in LTE an RRConnectionReconfiguratioComplete message and in NR an RRCReconfigurationComplete message) on SRB1 encrypted and integrity protected based on new security keys upon accessing the target access node.

FIG. 2 illustrates the signaling flow between UE, source access node (also known as source gNB, source eNB or source cell) and target access node (also known as target gNB, target eNB or target cell) during a handover procedure, using LTE as example.

Specifically, at step 1, a measurement report is sent from the UE to the source eNB. Thereafter, user data is exchanged between the UE and the source eNB and the source eNB and the SGW. At step 2, the source eNB performs a handover (HO) decision. At step 3, the source eNB sends a handover request to the target eNB. At step 4, the target eNB sends a HO request acknowledgement to the source eNB. At step 5, the source eNB sends a RCC connection reconfiguration message to the UE. At step 6, the UE detaches from the source cell. At step 7, the source eNB sends a SN status transfer message to the target eNB. Thereafter data is forwarded from the source eNB to the target eNB. At step 8, random access is performed between the UE and the target eNB. At step 9, a RRC connection reconfiguration complete message is transmitted from the UE to the target eNB. Thereafter, user data is exchanged between the UE and the target eNB. At step 10, the target eNB sends the MME a path switch request. At step 11, the MME and the SGW exchange path switch related signaling. Thereafter, user data is exchanged between the target eNB and the SGW, and the SGW sends an end marker to the target eNB, which then forwards it to the source eNB, which then returns it to the target eNB. At step 12, the target eNB sends a path switch request acknowledgement to the MME. The target eNB then transmits a UE context release message to the source eNB, at step 13.

Depending on the required Quality of Service (QoS), either a seamless or a lossless handover is performed as appropriate for each user plane radio bearer, as explained in the following subsections.

Seamless Handover

Seamless handover is applied for user plane radio bearers mapped on Radio Link Control (RLC) Unacknowledged Mode (UM). These types of data are typically reasonably tolerant of losses but less tolerant of delay (e.g. voice services). Seamless handover is therefore designed to minimize complexity and delay but may result in loss of some Packet Data Convergence Protocol (PDCP) Service Data Units (SDUs).

At handover, for radio bearers to which seamless handover applies, the PDCP entities including the header compression contexts are reset, and the COUNT values are set to zero. As a new key is anyway generated at handover, there is no security reason to maintain the COUNT values. PDCP SDUs in the UE for which the transmission has not yet started will be transmitted after handover to the target access node. In the source access node, PDCP SDUs that have not yet been transmitted can be forwarded via the X2/Xn interface to the target access node. PDCP SDUs for which the transmission has already started but that have not been successfully received will be lost. This minimizes the complexity because no context (i.e. configuration information) has to be transferred between the source access node and the target access node at handover.

Lossless Handover

Based on the sequence number (SN) that is added to PDCP Data Packet Data Units (PDUs) it is possible to ensure in-sequence delivery during handover, and even provide a fully lossless handover functionality, performing retransmission of PDCP SDUs for which reception has not yet been acknowledged prior to the handover. This lossless handover function is used mainly for delay-tolerant services such as file downloads where the loss of one PDCP SDU can result in a drastic reduction in the data rate due to the reaction of the Transmission Control Protocol (TCP).

Lossless handover is applied for user plane radio bearers that are mapped on RLC Acknowledged Mode (AM). When RLC AM is used, PDCP SDUs that have been transmitted but not yet been acknowledged by the RLC layer are stored in a retransmission buffer in the PDCP layer.

In order to ensure lossless handover in the downlink (DL), the source access node forwards the DL PDCP SDUs stored in the retransmission buffer as well as fresh DL PDCP SDUs received from the gateway to the target access node for (re-)transmission. The source access node receives an indication from the core network gateway (SGW in LTE/EPC, UPF in LTE/5GC and NR) that indicates the last packet sent to the source access node (a so called “end marker” packet). The source access node also forwards this indication to the target access node so that the target access node knows when it can start transmission of packets received directly from the gateway.

In order to ensure lossless handover in the uplink (UL), the UE retransmits the UL PDPC SDUs that are stored in the PDCP retransmission buffer in the target access node. The retransmission is triggered by the PDCP re-establishment that is performed upon reception of the handover command. The source access node, after decryption and decompression, will forward all PDCP SDUs received out of sequence to the target access node. Thus, the target access node can reorder the PDCP SDUs received from the source access node and the retransmitted PDCP SDUs received from the UE based on the PDCP SNs which are maintained during the handover, and deliver them to the gateway in the correct sequence.

An additional feature of lossless handover is so-called selective retransmission. In some cases it may happen that a PDCP SDU has been successfully received, but a corresponding RLC acknowledgement has not. In this case, after the handover, there may be unnecessary retransmissions initiated by the UE or the target access node based on the incorrect status received from the RLC layer. In order to avoid these unnecessary retransmissions a PDCP status report can be sent from the target access node to the UE and from the UE to the target access node. Whether to send a PDCP status report after handover is configured independently for each radio bearer and for each direction.

### Rel-16 Dual Active Protocol Stacks (DAPS) Handover

To address the shortcomings of Rel-14 MBB and achieve ˜0 ms interruption time an enhanced version of Make-Before-Break (MBB), also known as Dual Active Protocol Stacks (DAPS) handover, is being specified for Rel-16 both for LTE and NR.

A DAPS Handover is defined as a handover procedure wherein the UE maintains the source gNB connection after reception of RRC message for handover (i.e. an RRCReconfiguration with a reconfigurationWithSync for the Master Cell Group (MCG)) and until releasing the source cell after successful random access to the target gNB.

During DAPS handover it is assumed that the UE is capable of simultaneously transmitting and receiving from the source and target cells. In practice, this may require that the UE is equipped with dual Tx/Rx chains. The dual Tx/Rx chains potentially also allows DAPS handover to be supported in other handover scenarios such as inter-frequency handover.

FIG. 3 illustrates an example of a DAPS inter-node handover for the case of LTE. Specifically, at step 1, a measurement report is sent from the UE to the source eNB. Thereafter, user data is exchanged between the UE and the source eNB and the source eNB and the SGW. At step 2, the source eNB performs a handover (HO) decision. At step 3, the source eNB sends a handover request to the target eNB. At step 4, the target eNB sends a HO request acknowledgement to the source eNB. At step 5, the source eNB sends a RCC connection reconfiguration message to the UE. At step 6, the source eNB sends a SN status transfer message to the target eNB. Thereafter data is forwarded from the source eNB to the target eNB and user data is exchanged between the UE and the source eNB and the source eNB and the target eNB. At step 7, random access is performed between the UE and the target eNB. At step 8, a RRC connection reconfiguration complete message is transmitted from the UE to the target eNB. Thereafter, user data is exchanged between the UE and the target eNB. At step 9, the target eNB sends the MME a path switch request. At step 10, the MME and the SGW exchange path switch related signaling. Thereafter, user data is exchanged between the target eNB and the SGW, and the SGW sends an end marker to the target eNB, which then forwards it to the source eNB, which then returns it to the target eNB. At step 11, the MME sends a path switch request acknowledgement to the target eNB. The target eNB then transmits a UE context release message to the source eNB, at step 12. At step 13, the UE releases the source cell.

It may be noted that, in step 5, upon receiving the “DAPS HO” indication in the Handover Command (set per bearer), e.g. an RRCReconfiguration with a reconfigurationWithSync for the MCG, the UE maintains the connection to the source cell associated to a source access node while establishing the connection to the target cell associated to a target access node (for the bearers configured with DAPS). That is, the UE can send and receive DL/UL user plane data via the source access node between step 5-8 without any interruption for the respective bearers. And after step 8, the UE has the target link available for UL/DL user plane data transmission similar to the regular HO procedure.

DAPS configuration for a given bearer is provided as part of the RadioBearerConfig, for each DRB to be configured with DAPS, as described in TS 38.331 v.16.1.0 wherein the RadioBearerConfig IE is included in the RRCReconfiguration with a reconfigurationWithSync for the MCG.

In case of DAPS handover, the UE continues the downlink user data reception from the source gNB until releasing the source cell, i.e. daps-SourceRelease message transmitted by the target, and continues the uplink user data transmission to the source gNB until successful random access procedure to the target gNB. In order to do that, the UE should keep performing radio link monitoring (RLM) with respect to the source cell for the whole duration of the handover, i.e. until RRCReconfigurationComplete containing HO completion information is transmitted. That implies for example that the UE should keep monitoring possible out-of-sync indications, whether the RLC retransmissions with the source exceed the threshold, etc., Obviously, in case RLF occurs in the source cell while performing DAPS, the UE releases the source connection, but it can continue the DAPS HO to the target.

As previously discussed, the UE configured with DAPS HO can continue with UL transmissions towards the source cell until the handover is completed in the target, i.e. RRCReconfigurationComplete is transmitted to the target. For the DL instead, the source network node (e.g. a source gNodeB) can keep sending DL data until the source configuration release, conveyed in the daps-SourceRelease message transmitted by the target (after having received the RRCReconfigurationComplete) is received by the UE. Hence, even though UL data transmission to the source cell will not be prolonged beyond the handover completion, some UL transmissions to the source cell should be performed towards the source cell after the handover completion, such as Hybrid Automatic Repeat Request (HARD) Acknowledgement (ACK)/Negative Acknowledgement (NACK) and other possible layer-1 control signaling.

The handover mechanism triggered by RRC requires the UE at least to reset the MAC entity and re-establish RLC, except for DAPS handover, where upon reception of the handover command, the UE:
Creates a MAC entity for target (i.e. a different/new MAC entity);
Establishes the RLC entity and an associated Dedicated Traffic Channel (DTCH) logical channel for target for each Data Radio Bearer (DRB) configured with DAPS;
For the DRB configured with DAPS, reconfigures the PDCP entity with separate security and Robust Header Compression (ROHC) functions for source and target and associates them with the RLC entities configured by source and target respectively;
Retains the rest of the source configurations until release of the source.

For DRBs configured with DAPS, the source gNB does not stop transmitting downlink packets until it receives the HANDOVER SUCCESS message from the target gNB. In RRC, UE actions are defined Sections 5.3.5.5.2, 5.3.5.5.4, and 5.3.5.5.5 in 3GPP TS 38.331 v.16.1.0.

For DRBs configured with DAPS, downlink PDCP SDUs are forwarded with Sequence Number (SN) assigned by the source node (gNB), until SN assignment is handed over to the target gNB (which only happens later in the execution procedure).

In step 6 of FIG. 3, the source access node sends an SN status transfer message to the target access node, indicating UL PDCP receiver status and the SN of the first forwarded DL PDCP SDU. The uplink PDCP SN receiver status includes at least the PDCP SN of the first missing UL SDU and may include a bit map of the receive status of the out of sequence UL SDUs that the UE needs to retransmit in the target cell, if there are any such SDUs. The SN Status Transfer message also contains the Hyper Frame Number (HFN) of the first missing UL SDU as well as the HFN DL status for COUNT preservation in the target access node. In other words, for DRBs configured with DAPS, the source access node (or simply source gNB) first sends the EARLY STATUS TRANSFER message. The DL COUNT value conveyed in the EARLY STATUS TRANSFER message indicates PDCP SN and HFN of the first PDCP SDU that the source gNB forwards to the target gNB. The source gNB does not stop assigning SNs to downlink PDCP SDUs until it sends the SN STATUS TRANSFER message to the target gNB in step 8b.

Once the connection setup with the target access node is successful, i.e. after sending the Handover Complete message in step 8 of FIG. 3, the UE maintains two data links, one to the source access node and one to the target access node (except in the UL where the UE only uses the target after successful random access). After step 8, the UE transmits the UL user plane data on the target access node similar to the regular HO procedure using the target access node security keys and compression context. Thus, there is no need for simultaneous UL user data transmission to both nodes which avoids UE power splitting between two nodes and also simplifies UE implementation. In the case of intra-frequency handover, transmitting UL user plane data to one node at a time also reduces UL interference which increases the chance of successful decoding at the network side.

The UE needs to maintain the security and compression context for both source access node and target access node until the source link is released. The UE can differentiate the security/compression context to be used for a PDCP PDU based on the cell which the PDU is transmitted on.

To avoid packet duplication, the UE may send a PDCP status report together with the Handover Complete message in step 408, indicating the last received PDCP SN. Based on the PDCP status report, the target access node can avoid sending duplicate PDCP packets (i.e. PDCP PDUs with identical sequence numbers) to the UE, i.e. PDCP packets which were already received by the UE in the source cell.

The release of the source cell in step 13 of FIG. 3 can, for example, be triggered by an explicit message from the target access node (not shown in the figure) or by some other event such as the expiry of a release timer.

As an alternative to source access node starting packet data forwarding after step 5 of FIG. 3 (i.e. after sending the Handover Command to the UE, also known as “early packet forwarding”), the target access node may indicate to the source access node when to start packet data forwarding. For instance, the packet data forwarding may start at a later stage when the link to the target cell has been established, e.g. after the UE has performed random access in the target cell or when the UE has sent the RRC Connection Reconfiguration Complete message to the target access node (also known as “late packet forwarding”). By starting the packet data forwarding in the source access node at a later stage, the number of duplicated PDCP SDUs received by the UE from the target cell will potentially be less and by that the DL latency will be somewhat reduced. However, starting the packet data forwarding at a later stage is also a trade-off between robustness and reduced latency if, for example, the connection between the UE and the source access node is lost before the connection to the target access node is established. In such case there will be a short interruption in the DL data transfer to the UE.

FIG. 4 illustrates the protocol stack at the UE side at DAPS handover.

Each user plane radio bearer has an associated PDCP entity which in turn has two associated RLC entities, two associated MAC, and two associated PHY—one each for the source cell and one each for the target cell. The PDCP entity uses different security keys and ROHC contexts for the source and target cell while the SN allocation (for UL transmission) and re-ordering/duplication detection (for DL reception) is common. The PDCP entity performs SN allocation for UL and re-ordering duplication detection for DL.

Note that in case of NR, there is an additional protocol layer called Service Data Adaptation Protocol (SDAP) on top of PDCP which is responsible for mapping QoS flows to bearers. This layer is not shown in FIG. 4 and will not be discussed further herein.

### DAPS Handover Failure

Timer based handover failure procedure is supported in NR (i.e. UE starts timer T304 when receives the RRCReconfiguration with reconfiguration with sync, and stops the timer when successful, and upon expiry declares handover failure). RRC connection re-establishment procedure is used for recovering from handover failure.

However, when DAPS HO fails, the UE has the possibility to fall back to source cell configuration, resumes the connection with source cell, and reports DAPS HO failure via the source without triggering RRC connection re-establishment if the source link has not been released. Obviously, such fallback to the source cell can only occur in case RLF with respect to the source cell has not been declared yet at the time the T304 expires. Once the UE has fell back to the source cell, it issues a failure information to indicate to the source cell that the UE failed the DAPS HO towards the target.

Otherwise, if RLF with respect to the source cell has already occurred at the time the DAPS handover to the target fails, i.e. T304 expires, the UE selects a third cell different from the source and the target for reestablishment. This feature is discussed in Section 5.3.5.8.3 and Section 5.7.5 of 3GPP TS 38.331 v16.1.0.

### Radio Link Monitoring (RLM) in LTE and NR

Radio Link Monitoring (RLM) is a procedure in RRC_CONNECTED to keep track of the radio link condition to support determination of whether RLF should be declared and to enable that appropriate steps can be taken if RLF is declared.

The details on RLM for LTE are further specified in 3GPP TS 36.133 v.16.6.0 section 7.11 and in 3GPP TS 36.213 v.16.2.0 section 4.2.1. The details on radio link monitoring for NR are further specified in 3GPP TS 38.133 v.16.4.0 section 8.1 and in 3GPP TS 38.213 v.16.2.0 section 5. The main principles for RLM are similar for LTE and NR. As part of this RLM, the physical layer in the UE performs a quality measurement on the radio link on a defined reference signal and provides “out-of-sync” and “in-sync” indications to the RRC layer.

As a criterion for providing the “out-of-sync” indication, a threshold Qₒᵤₜ is defined. When the quality is below this threshold, the downlink radio link cannot be reliably received and this corresponds by default to 10% block error rate of a hypothetical physical downlink control channel (PDCCH) transmission.

As a criterion for providing the “in-sync” indication, a threshold Qᵢₙ is defined. When the quality is above this threshold, downlink radio link quality can be significantly more reliably received than at Qₒᵤₜ and corresponds by default to a 2% block error rate of a hypothetical PDCCH transmission.

The details on how the thresholds Qₒᵤₜ and Qᵢₙ are defined are further specified in TS 36.133 v.16.6.0 and TS 38.133 v.16.4.0, for LTE and NR, respectively.

In LTE, when in non-Discontinuous Reception (non-DRX) mode, the physical layer evaluates the thresholds Qₒᵤₜ and Qᵢₙ for each radio frame. It indicates “out-of-sync” to the Radio Resource Control (RRC) layer when the radio link quality is worse than the threshold Qₒᵤₜ and “in-sync” when the radio link quality is better than the threshold Qᵢₙ In LTE, when in Discontinuous Reception (DRX) mode operation, the physical layer in the UE shall at least once every DRX period assess the radio link quality.

In NR, the physical layer in the UE assesses once per indication period the radio link quality. When in non-DRX mode operation, the UE determines the indication period as the maximum between the shortest of the periodicity for radio link monitoring resources and 10 msec. When in DRX mode operation, the UE determines the indication period as the maximum between the shortest periodicity for radio link monitoring resources and the DRX period.

FIG. 5 illustrates the “out-of-sync” and “in-sync” indications exchanged between the UE physical layer and the UE RRC layer. The “out-of-sync” and “in-sync” indications from the physical layer are processed by the RRC layer (this processing is also known as “Layer3 filtering” or “L3 filtering”). Upon a certain number of (known as the parameter/counter N310) consecutive “out-of-sync” indications generated by the radio link monitoring in the physical layer, the RRC layer starts a timer (usually known as timer T310). If the physical layer then provides a certain number of (known as the parameter N311) consecutive “in-sync” indications while this timer is running, the UE has recovered from a sync problem and stops the timer T310.

When the timer T310 expires, a RLF condition is declared and the UE performs cell selection and RRC connection re-establishment. During cell selection, the UE finds a suitable cell which fulfils the criteria Sin 3GPP TS 36.304 v. 16.1 (for LTE cells) or in 3GPP TS 38.304 v. 16.1 (for NR cells). According to those specifications, the cell selection criterion S is fulfilled when Srxlev>0 AND Squal>0. How Srxlev and Squal are defined is further specified in those specifications.

During handover the UE does not perform RLM in the source cell. When the handover command is received by the UE, it starts timer T304. The timer T304 is stopped after successful handover (i.e. when the UE has transmitted handover complete to the target access node). If the timer T304 expires, the UE determines that the handover has failed and initiates cell selection and RRC connection re-establishment.

### Self-Organising Networks (SON) in 3GPP

A Self-Organizing Network (SON) is an automation technology designed to make the planning, configuration, management, optimization and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, the processes within the SON area are classified into Self-configuration process and Self-optimization process. Self-configuration process is the process where newly deployed nodes are configured by automatic installation procedures to get the necessary basic configuration for system operation.

This process works in pre-operational state. Pre-operational state is understood as the state from when the eNB is powered up and has backbone connectivity until the RF transmitter is switched on.

FIG. 6 illustrates the ramifications of Self-Configuration/Self-Optimization functionality as disclosed in 3GPP TS 36.300 v.16.2.0. Specifically, as illustrated in FIG. 5, functions handled in the pre-operational state like: Basic Setup; and
Initial Radio Configuration.

are covered by the Self Configuration process.

Self-optimization process is defined as the process where UE and access node measurements and performance measurements are used to auto-tune the network.

This process works in operational state. Operational state is understood as the state where the RF interface is additionally switched on.

As described in FIG. 6, functions handled in the operational state like:
Optimization/Adaptation

are covered by the Self Optimization process

In LTE, support for Self-Configuration and Self-Optimisation is specified, as described in 3GPP TS 36.300 v.16.2.0 Section 22.2, including features such as Dynamic configuration, Automatic Neighbour Relation (ANR), Mobility load balancing, Mobility Robustness Optimization (MRO), RACH optimization and support for energy saving.

In NR, support for Self-Configuration and Self-Optimisation is specified as well, starting with Self-Configuration features such as Dynamic configuration, Automatic Neighbour Relation (ANR) in Rel-15, as described in 3GPP TS 38.300 v.16.2.0 section 15. In NR Rel-16, more SON features are being specified for, including Self-Optimisation features such as Mobility Robustness Optimization (MRO).

### Mobility Robustness Optimization (MRO) in 3GPP

Seamless handovers are a key feature of 3GPP technologies. Successful handovers ensure that the UE moves around in the coverage area of different cells without causing too much interruptions in the data transmission. However, there will be scenarios when the network fails to handover the UE to the ‘correct’ neighbor cell in time and in such scenarios the UE will declare the radio link failure (RLF) or Handover Failure (HOF).

Upon HOF and RLF, the UE may take autonomous actions such as, for example, trying to select a cell and initiate reestablishment procedure so that we make sure the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell (random access procedure, RRC Reestablishment Request, RRC Reestablishment RRC Reestablishment Complete, RRC Reconfiguration and RRC Reconfiguration Complete) and adds some latency, until the UE can exchange data with the network again.

According to at least 3GPP TS 36.331 v.14.14.0, the possible causes for the radio link failure could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the MAC entity;

As RLF leads to reestablishment which degrades performance and user experience, it is in the interest of the network to understand the reasons for RLF and try to optimize mobility related parameters (e.g. trigger conditions of measurement reports) to avoid later RLFs. Before the standardization of MRO related report handling in the network, only the UE was aware of some information associated to how did the radio quality looked like at the time of RLF, what is the actual reason for declaring RLF etc. For the network to identify the reason for the RLF, the network needs more information, both from the UE and also from the neighboring base stations.

As part of the MRO solution in LTE, the RLF reporting procedure was introduced in the RRC specification in Rel-9 RAN2 work. That has impacted the RRC specifications in the sense that it was standardized that the UE would log relevant information at the moment of an RLF and later report to a target cell the UE succeeds to connect (e.g. after reestablishment). That has also impacted the inter-gNodeB interface, i.e., X2AP specifications, as an eNodeB receiving an RLF report could forward to the eNodeB where the failure has been originated.

For the RLF report generated by the UE, its contents have been enhanced with more details in the subsequent releases. The measurements included in the measurement report based on the latest LTE RRC specification [Reference 1] are:
1) Measurement quantities (RSRP, RSRQ) of the last serving cell (PCell).
2) Measurement quantities of the neighbor cells in different frequencies of different RATs (EUTRA, UTRA, GERAN, Code Division Multiplexing Access-2000 (CDMA2000).
3) Measurement quantity (RSSI) associated to WLAN Aps.
4) Measurement quantity (RSSI) associated to Bluetooth beacons.
5) Location information, if available (including location coordinates and velocity)
6) Globally unique identity of the last serving cell, if available, otherwise the PCI and the carrier frequency of the last serving cell.
7) Tracking area code of the PCell.
8) Time elapsed since the last reception of the ‘Handover command’ message.
9) C-RNTI used in the previous serving cell.
10) Whether or not the UE was configured with a DRB having QCI value of 1.

The detection and logging of the RLF related parameters is captured in section 5.3.11.3 of LTE RRC specification 3GPP TS 36.331 v.14.14.0.

After the RLF is declared, the RLF report is logged and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report (stored in a UE variable VarRLF-Report, as described above) in an UEInformationResponse message and send to the network.

Based on the RLF report from the UE and the knowledge about which cell did the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as too-early, too-late or handover to wrong cell classes. These handover failure classes are explained in brief below.

For example, the original serving cell can classify a handover failure to be ‘too late handover’ when the original serving cell fails to send the handover command to the UE associated to a handover towards a particular target cell and if the UE reestablishes itself in this target cell post RLF.

An example corrective action from the original serving cell could be to initiate the handover procedure towards this target cell a bit earlier by decreasing the CIO (cell individual offset) towards the target cell that controls when the IE sends the event triggered measurement report that leads to taking the handover decision. However, the original serving cell can classify a handover failure to be ‘too early handover’ when the original serving cell is successful in sending the handover command to the UE associated to a handover however the UE fails to perform the random access towards this target cell.

An example corrective action from the original serving cell could be to initiate the handover procedure towards this target cell a bit later by increasing the CIO (cell individual offset) towards the target cell that controls when the IE sends the event triggered measurement report that leads to taking the handover decision.

As another example, the original serving cell can classify a handover failure to be ‘handover-to-wrong-cell’ when the original serving cell intends to perform the handover for this UE towards a particular target cell but the UE declares the RLF and reestablishes itself in a third cell.

A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

Two different types of inter-node messages have been standardized in 3GPP TS 36.423 v.16.2.0 for that purpose in LTE, the Radio link failure indication and the handover report.

The Radio link failure indication procedure is used to transfer information regarding RRC re-establishment attempts or received RLF reports between eNBs. This message is sent from the eNB in which the UE performs reestablishment to the eNB which was the previous serving cell of the UE. The contents of the RLF indication message is given below.

Certain problems exist, however. For example, there may be problems associated to the DAPS failure handling. In legacy DAPS, the UE starts a timer T304 when it received the HO command with DAPS while it continues to monitor the RLF trigger(s) in the source (timer T310 continues to run, if running i.e. it's not stopped). If timer T304 expires and RLF is not declared with the PCell (i.e. T310 has not expired) the UE fallback to source (reverting a set of configurations) and reports the DAPS failure via source. Currently, that report is transmitted in a FailureInformation message (whose procedure for transmission is defined in 5.7.5 in RRC, 3GPP TS 38.331 v.16.1.0) and only consists of an indication that DAPS handover has failed.’

Accordingly, a first problem exists in that scenarios may occur where that report/DAPS failure information could be lost. If the UE falls back to source and, before it is able to send the failure report, it declares RLF (T310 that is running may expiry while the UE is doing fallback) and triggers re-establishment. Or, in case an RLF is declared while timer T304 is running, the RLF report is logged but does not mention anything about DAPS.

A second problem exists in that, upon successful Radio Access Channel (RACH) procedure towards the DAPS target cell, T310 source stops and UE starts RLF monitoring in the target cell. RLF in the target cell may happen before DAPS release is received while the data is being received from the source cell but the UE cannot perform the source cell fallback.

In summary, if T304 expires during DAPS HO, the UE falls back to the source cell/network node, but RLF may be triggered in the source cell before DAPS failure is reported to the source network node. Additionally, even if the random-access procedure of the DAPS HO succeeds towards the DAPS target cell, RLF may happen in the target cell a few moments after.

### SUMMARY

Certain aspects of the present disclosure and their embodiments may provide solutions to these or other challenges. For example, according to certain embodiments, methods and systems are provided to enhance the dual active protocol stack handover (DAPS HO) decisions by the network. Specifically, according to certain embodiments, methods and systems by the wireless device are provided for reporting Control Plane (CP) related information in a successful handover report.

According to certain embodiments, a method by a wireless device includes declaring a radio link failure (RLF) in a source cell of a source network node during a DAPS HO from the source cell of the source network node to a target cell of a target network node. The wireless device stores information associated with the DAPS HO and information associated with the RLF. The wireless device transmits the information to an access node.

According to certain embodiments, a method by a network node receiving, from a wireless device, information associated with a DAPS HO and a RLF. The RLF is in a source cell of a source network node, and the DAPS HO is from the source cell of the source network node to a target cell of a target network node.

According to certain embodiments, a wireless device includes processing circuitry configured to declare a RLF in a source cell of a source network node during a DAPS HO from the source cell of the source network node to a target cell of a target network node. The processing circuitry is configured to store information associated with the DAPS HO and information associated with the RLF. The processing circuitry is configured to transmit the information to an access node.

According to certain embodiments, a network node includes processing circuitry configured to receive, from a wireless device, information associated with a DAPS HO and a RLF. The RLF is in a source cell of a source network node, and the DAPS HO is from the source cell of the source network node to a target cell of a target network node.

According to certain embodiments, a network node is adapted to receive, from a wireless device, information associated with a DAPS HO and a RLF. The RLF is in a source cell of a source network node, and the DAPS HO is from the source cell of the source network node to a target cell of a target network node.

Certain embodiments may provide one or more of the following technical advantages. For example, one technical advantage may be that certain embodiments provide the network with an information related to the DAPS handover performance in terms of underlaying issues (e.g. DAPS handover failure, RLF). Another technical advantage may be that certain embodiments allow to identify the reasons for the failed DAPS handover based on the DAPS handover failure message contents in the RLF report and improve handover parameter tuning and optimization.

As another example, one technical advantage may be that certain embodiments may prevent information loss regarding DAPS handover failure in case of falling back to the source cell with subsequently declaring RLF in the source cell, ensuring that information (with corresponding measurements) regarding DAPS handover failure is available to the network (e.g. reestablishment or reconnection cell).

As another example, one technical advantage may be that certain embodiments may prevent information loss regarding unsuccessful DAPS handover due to the RLF in a target cell that occurred before reception of the daps-SourceRelease. Further root cause analysis of such information can indicate the reason of the failure (e.g. too early handover) and improve handover configuration in the source or target cell.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a simplified 3rd Generation Partnership Project (3GPP) wireless communication system;

FIG. 2 illustrates signaling flow between a user equipment (UE), source access node and target access node during a handover procedure in an Long Term Evolution (LTE) network;

FIG. 3 illustrates an example of a Dual Active Protocol Stack (DAPS) inter-node handover for the case of LTE;

FIG. 4 illustrates the protocol stack at the UE side at DAPS handover;

FIG. 5 illustrates the “out-of-sync” and “in-sync” indications exchanged between the UE physical layer and the UE RRC layer;

FIG. 6 illustrates the ramifications of Self-Configuration/Self-Optimization functionality as disclosed in 3GPP TS 36.300;

FIG. 7 illustrates an example wireless network, according to certain embodiments;

FIG. 8 illustrates an example network node, according to certain embodiments;

FIG. 9 illustrates an example wireless device, according to certain embodiments;

FIG. 10 illustrate an example user equipment, according to certain embodiments;

FIG. 11 illustrates a virtualization environment in which functions implemented by some embodiments may be virtualized, according to certain embodiments;

FIG. 12 illustrates a telecommunication network connected via an intermediate network to a host computer, according to certain embodiments;

FIG. 13 illustrates a generalized block diagram of a host computer communicating via a base station with a user equipment over a partially wireless connection, according to certain embodiments;

FIG. 14 illustrates a method implemented in a communication system, according to one embodiment;

FIG. 15 illustrates another method implemented in a communication system, according to one embodiment;

FIG. 16 illustrates another method implemented in a communication system, according to one embodiment;

FIG. 17 illustrates another method implemented in a communication system, according to one embodiment;

FIG. 18 illustrates an example method by a wireless device, according to certain embodiments;

FIG. 19 illustrates an exemplary virtual computing device, according to certain embodiments;

FIG. 20 illustrates an example method by a network node, according to certain embodiments; and

FIG. 21 illustrates another exemplary virtual computing device, according to certain embodiments.

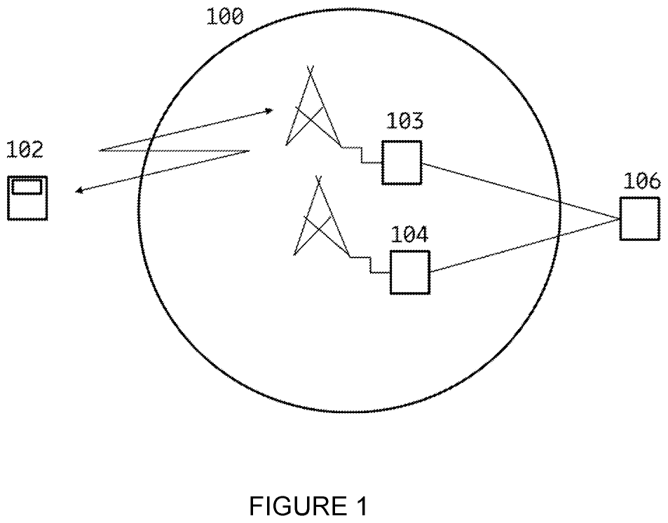

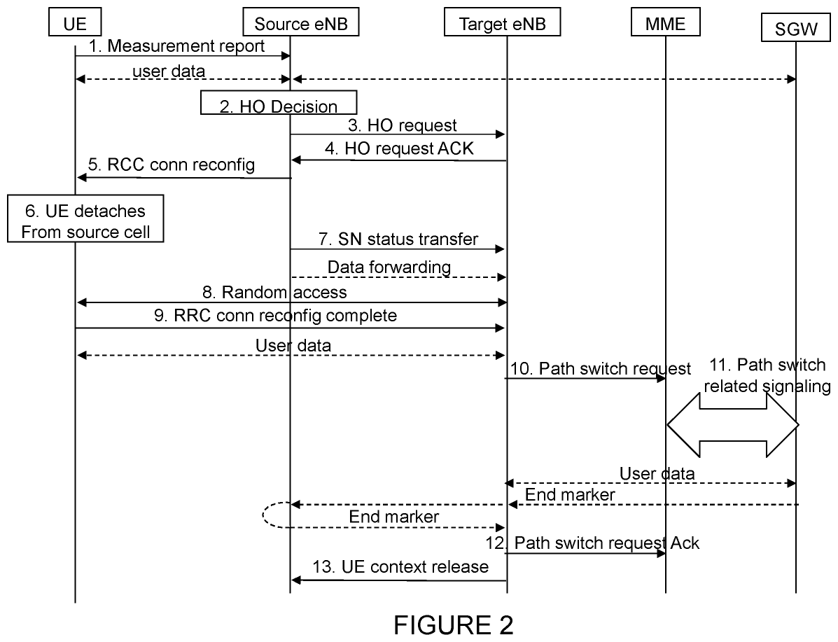

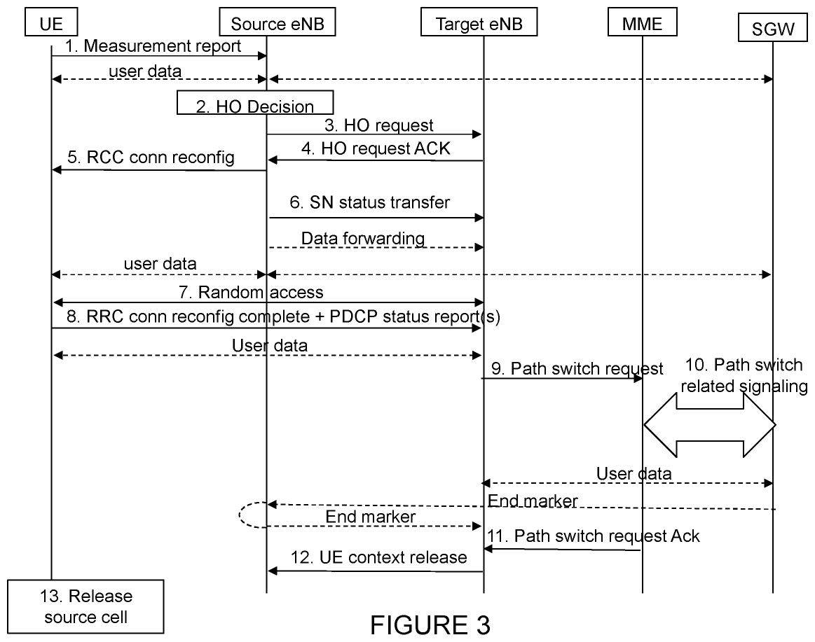

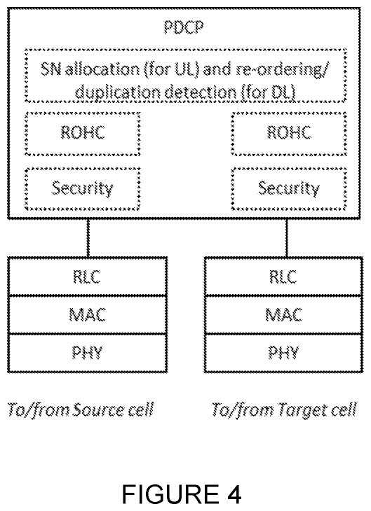

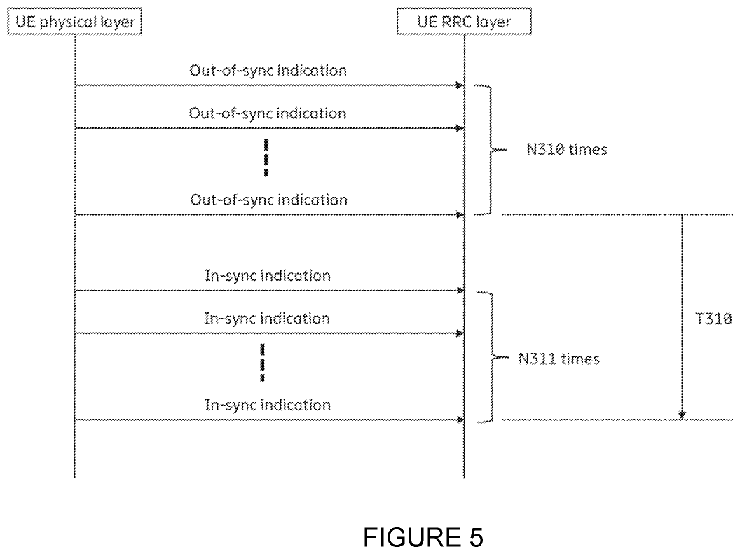

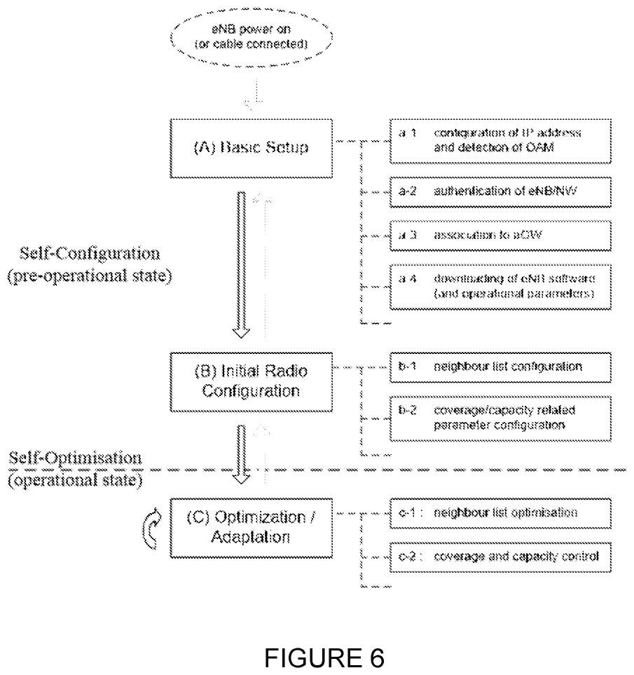

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations and Maintenance (O&M), Operations Support System (OSS), Self Optimizing Network (SON), positioning node (e.g. Evolved-Serving Mobile Location Centre (E-SMLC)), Minimization of Drive Test (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems are provided to enhance the dual active protocol stack handover (DAPS HO) decisions by the network. Specifically, according to certain embodiments, methods and systems by the wireless device are provided for reporting control plane (CP) related information in a successful handover report.

For example, according to certain embodiments, a method by the wireless device is provided to enhance the DAPS HO decisions. The method may include:
Receiving a DAPS handover command from the first network node.
Failing to perform access to DAPS handover target before the expiry of T304 timer, thus declaring DAPS handover failure.
Performing source fallback and attempting to transmit DAPS handover failure message to the source.
Declaring RLF before successfully sending DAPS handover failure message to the source.
Generating an RLF report and storing one or more set of measurements in the RLF report that includes the measurements that were part of DAPS handover failure message. The measurements further including
   Radio measurements of source and target cells
   Radio measurements of neighboring cells
   Time between the declaring DAPS HOF and declaring RLF.
   Status of timer T310 while receiving DAPS HO command
Performing re-establishment or reconnection.
Indicating the availability of RLF report
Receiving a request to transmit the RLF report
Transmitting the RLF report

According to certain embodiments, methods by a network node in the reestablishment or reconnection cell are provided to enhance the DAPS HO decisions. The methods may include:
Receiving an indication about the availability of RLF report
Sending a request to transmit the RLF report
Receiving the RLF report
Transmitting the RLF report to the failed PCell (source cell of DAPS HO) stored in the RLF report

According to certain embodiments, methods by a network node in a source cell of the DAPS HO are provided. The method may include:
Receiving the RLF report from the reestablishment or reconnection cell.
Extracting the information related to the failed DAPS handover and further identifying the reasons for the failed DAPS handover based on the DAPS handover failure message contents in the RLF report
Tuning the DAPS HO parameters

According to certain embodiments, a method by the wireless device is provided to enhance the DAPS HO decisions by the network. The method may include:
Receiving a DAPS handover command from the first network node.
Successfully performing access to the DAPS handover target before the expiry of T304 timer.
Declaring RLF before receiving the daps-SourceRelease.
Generating an RLF report and including one or more of the following measurements.
   Indication that the DAPS handover was not successful although the RLF was declared in the target of the DAPS handover
   Indication that there was a lack of reception of daps-SourceRelease from the target
   Indication that the UE was successful in sending the RRCReconfigurationComplete to the target cell.
   Indication regarding whether the DL data reception from the source was available at the time of declaring the RLF
   Radio measurements of source of the DAPS handover
   Time of sending RRCReconfigurationComplete message to the DAPS target to the time of declaring RLF (time XX).
Performing re-establishment or reconnection.
Indicating the availability of RLF report
Receiving a request to transmit the RLF report
Transmitting the RLF report

According to certain embodiments, methods by a network node in the reestablishment or reconnection cell are provided to enhance the DAPS HO decisions. The method may include:
Receiving an indication about the availability of RLF report
Sending a request to transmit the RLF report
Receiving the RLF report
Transmitting the RLF report to the failed PCell (target cell of DAPS HO) stored in the RLF report

According to certain embodiments, methods by a network node in a target cell of the DAPS HO are provided. The method may include:
Receiving the RLF report from the reestablishment or reconnection cell.
Analyzing the information in RLF report to determine whether the root cause of the failure resides in the source of DAPS handover or the target of DAPS handover.
   As an example, determining whether the DAPS HO was a too early HO from the source of DAPS (e.g., small value of time XX) or was it the delayed release of source by itself (e.g., large value of time XX)
      further, if the UE successfully connected to the target (second) network node and if the second network node determined that the failure at the UE was not due to radio conditions or in general it was not due to a suboptimal configuration of DAPS handover parameters, the second network node may deem the issue contained within the second network node and avoid signaling the measurements and information from the UE to the first network node. In this case the second network node may apply changes to its own configuration to address future similar failure cases.
If the cause is determined to be due to source of DAPS handover (e.g., too early DAPS HO), Transmitting the RLF report to the source cell of DAPS HO and indicating the too early DAPS HO.
   In one example of such embodiment such transmission can be done over the Xn interface by means of the Failure Indication procedure. Alternatively, the ACCESS AND MOBILITY INDICATION procedure may be used to transmit such information.

According to certain embodiments, methods by a network node in a source cell of the DAPS HO are provided. The method may include:
Receiving the RLF report from the target cell of DAPS HO and an indication of the too early DAPS HO
   In one example of such embodiment such reception can occur over the Xn interface by means of the Failure Indication procedure. Alternatively, the ACCESS AND MOBILITY INDICATION procedure may be used to receive such information.
Analyzing the performance of the previous mobility decisions based on the received one or more set of information.
Configuring new DAPS HO decisions to one or more of UEs based on the analyzed performance

According to certain embodiments, instead of storing DAPS Failure information in the RLF report, a new failure report is generated that captures information about DAPS failure and the RLF report.

As part of the DAPS failure information included in the RLF report, the information further consists of any one or more of:
Cell identity of the target cell of DAPS HO.
   This information may be useful to identify the failed DAPS handover target in the future when the RLF report containing the DAPS failure information is received by the source of the failed DAPS HO.
Radio measurements related to the source cell and/or to the target cell, e.g. the latest available radio measurement at the point in time in which the storing action occurs in conjunction with the above events
Information related to the UP performances during the handover, such as the HO interruption time during DAPS, packet lost at DAPS, etc.
Status of RLM parameters associated to the source network node, e.g. T310 status of the first network node, T304 of the second network node status (if the UE declares HOF in target because of maximum number of RA attempts), number of RLC retransmissions at the source before declaring HOF.
An indication of the time associated to:
   The time elapsed between DAPS HO command reception and fallback to the first network node.
   The time elapsed between DAPS HO command reception and RLF in the first network node.
   The time elapsed between DAPS HO command reception and handover failure in the second network node.

According to certain other embodiments, as part of the DAPS target RLF report, the information may further consists of at least one of:
Radio measurements related to the source cell and/or to the target cell, e.g. the latest available radio measurement at the point in time in which the storing action occurs in conjunction with the above events.
Information related to the UP performances during the handover, such as the HO interruption time during DAPS, packet lost at DAPS, etc.
Status of RLM parameters associated to the first network node at the time of stopping monitoring RLM towards the source (i.e., at the time of completing the RA procedure towards the DAPS HO target cell). This information is useful to know if the source link quality was very good at the time of completing the DAPS HO or not. Such a status could be one or more of:
   T310 status, i.e., whether it had expired or not and if not expired then indicating whether it was running or not, if running then indicating the actual value of it.
   Number of successive OOS (out of sync) indications from lower layer.
   Number of successive IS (in sync) indications from lower layer.
   Whether the beam failure recovery was ongoing.
An indication that the previous HO was associated to a DAPS HO.
An indication of the time associated to:
   The time elapsed between DAPS HO command reception and HO completion, i.e. transmission of the RRCReconfigurationComplete to the second network node
   The time elapsed between HO completion and the RLF declaration

In the example embodiments described above, the report contents could be further communicated within the node in a split architecture deployments. If the network node which needs to take an action is a split gNB made of a gNB-DU and a gNB-CU, the gNB-CU of such a network node may decide to signal such report contents to the gNB-DU. The gNB-DU may take this information into account to optimize its configurations, for example to optimize parameters relative to RACH, beam configuration, cell configuration.

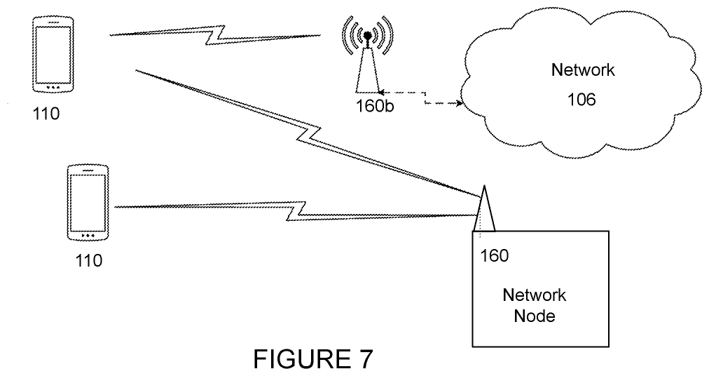

FIG. 7 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

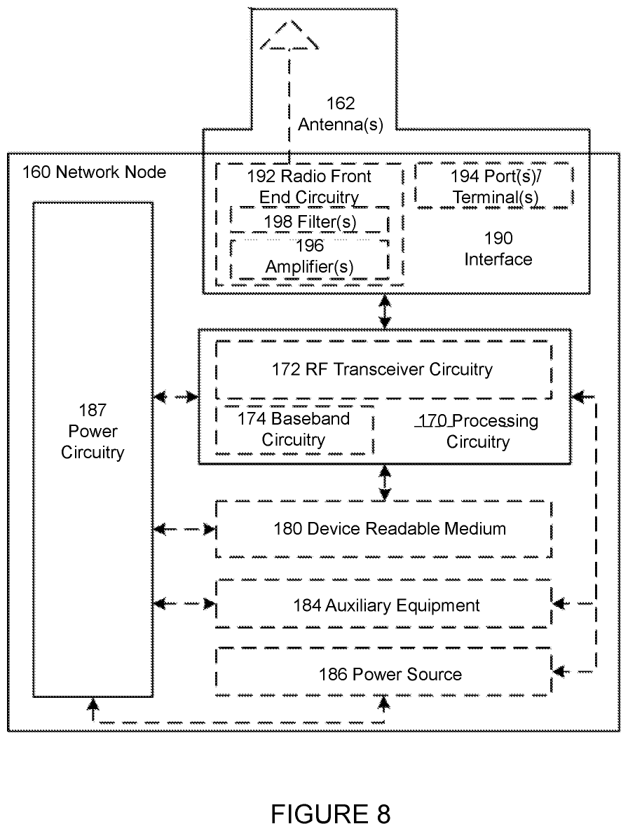

FIG. 8 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 160 includes processing circuitry 170, device readable medium 180, interface 190, auxiliary equipment 184, power source 186, power circuitry 187, and antenna 162. Although network node 160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, Global System for Mobile Communications (GSM), Wideband Code Division Multiplexing Access (WCDMA), Long Term Evolution (LTE), New Radio (NR), WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

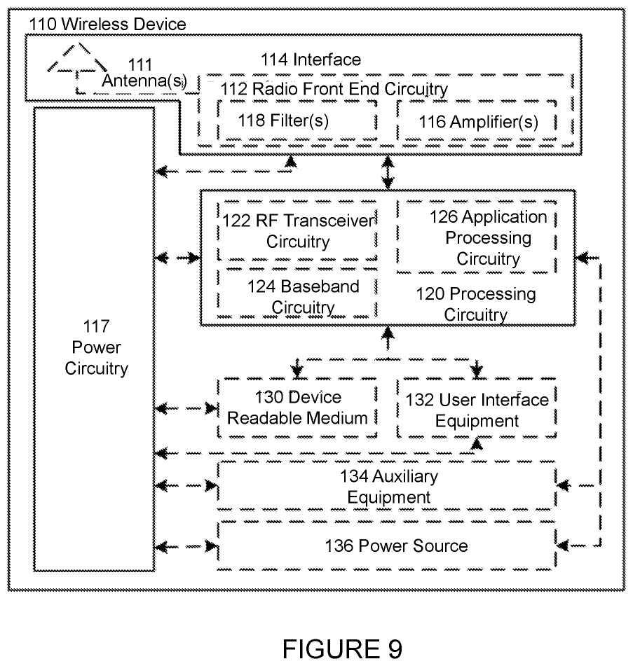

FIG. 9 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

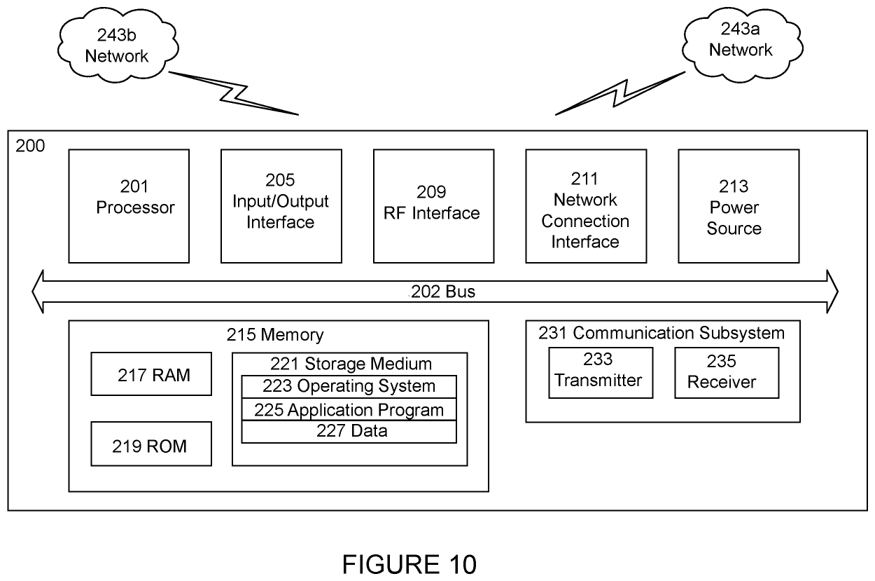

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 8, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 10 is a UE, the components discussed herein are equally applicable to a wireless device, and vice-versa.

In FIG. 10, UE 200 includes processor 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processor 201 may be configured to process computer instructions and data. Processor 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processor 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processor 201 to provide storage or caching of data or computer instructions during the execution of software programs such as the operating system, application programs, and device drivers. ROM 219 may be configured to provide computer instructions or data to processor 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processor 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processor 201 may be configured to communicate with any of such components over bus 202. In another example, any of such components may be represented by program instructions stored in memory that when executed by processor 201 perform the corresponding functions described herein. In another example, the functionality of any of such components may be partitioned between processor 201 and communication subsystem 231. In another example, the non-computationally intensive functions of any of such components may be implemented in software or firmware and the computationally intensive functions may be implemented in hardware.

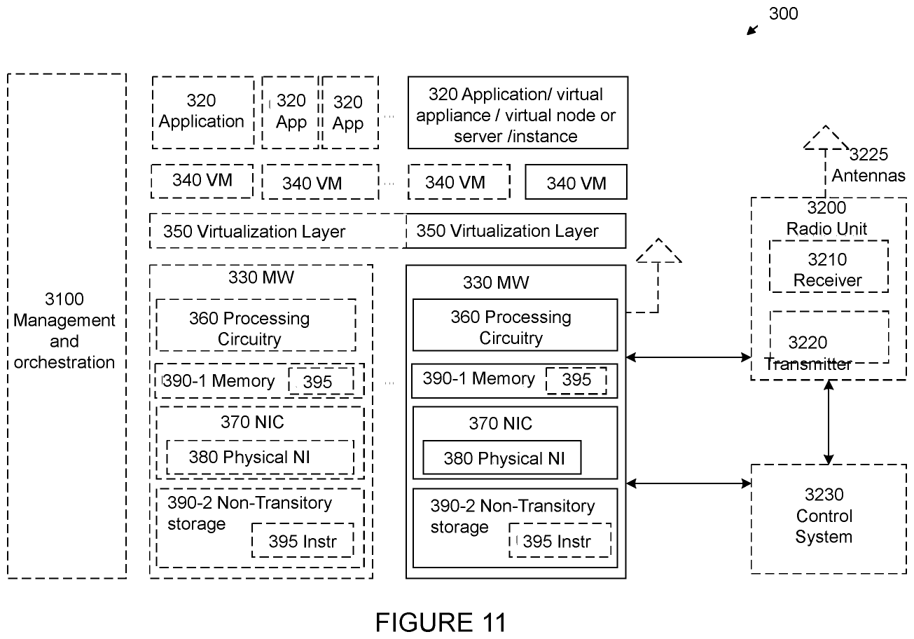

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides middleware (MW) 330 comprising processing circuitry 360 and memory 390-1. Memory 390-1 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device 330 may comprise memory 390-1 which may be non-persistent memory for temporarily storing instructions 395 or software executed by processing circuitry 360. Each hardware device 330 may comprise one or more network interface controllers (NICs) 370, also known as network interface cards, which include physical network interface 380. Each hardware device 330 may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines (VMs) 340 as well as software allowing it to execute functions, features and/or benefits described in relation with some embodiments described herein.

VMs 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, VM 340 may be a software implementation of a physical machine that runs programs as if they were executing on a physical, non-virtualized machine. Each of VMs 340, and that part of hardware 330 that executes that VM, be it hardware dedicated to that VM and/or hardware shared by that VM with others of the VMs 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

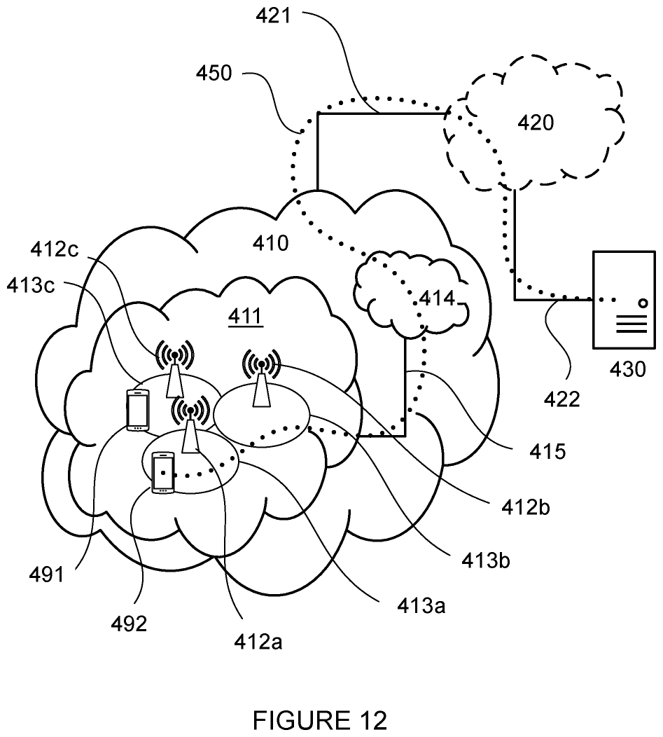

FIG. 12 illustrates a telecommunication network connected via an intermediate network to a host computer in accordance with some embodiments. With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

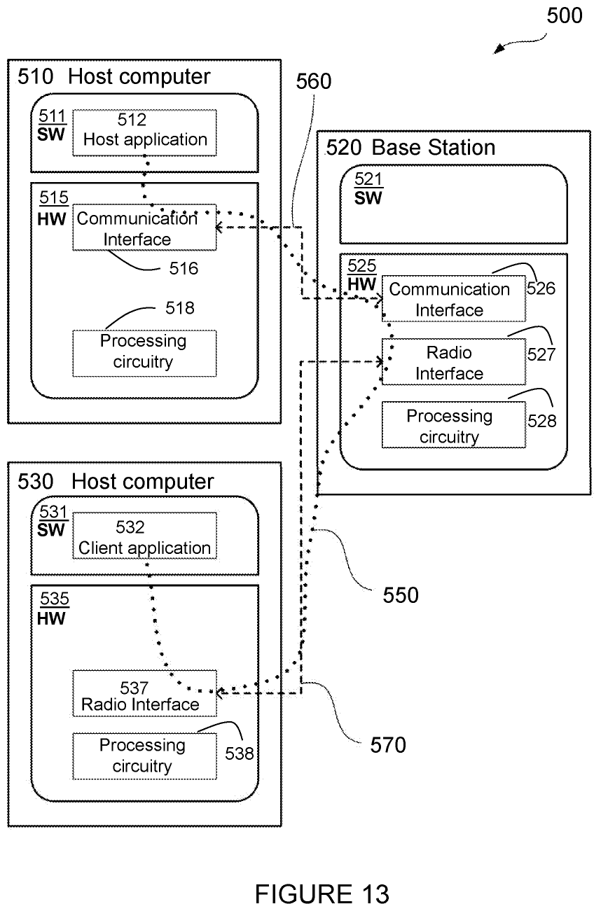

FIG. 13 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

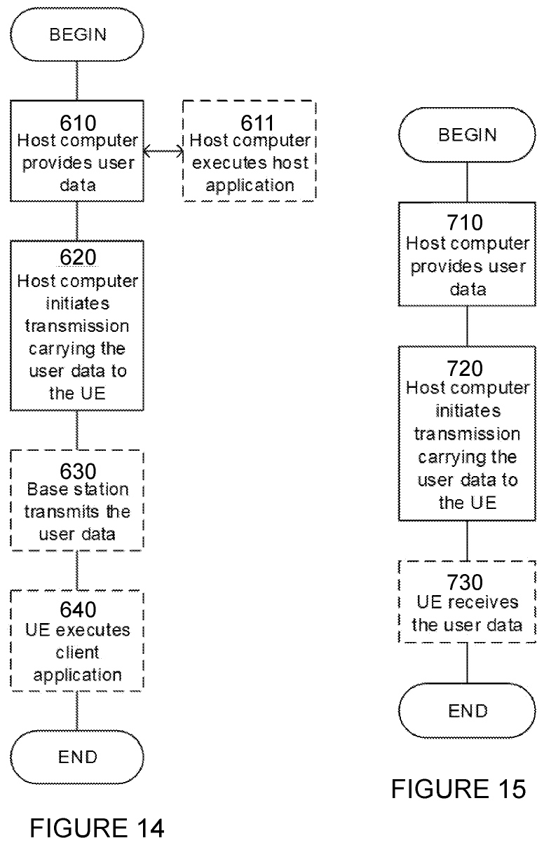

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

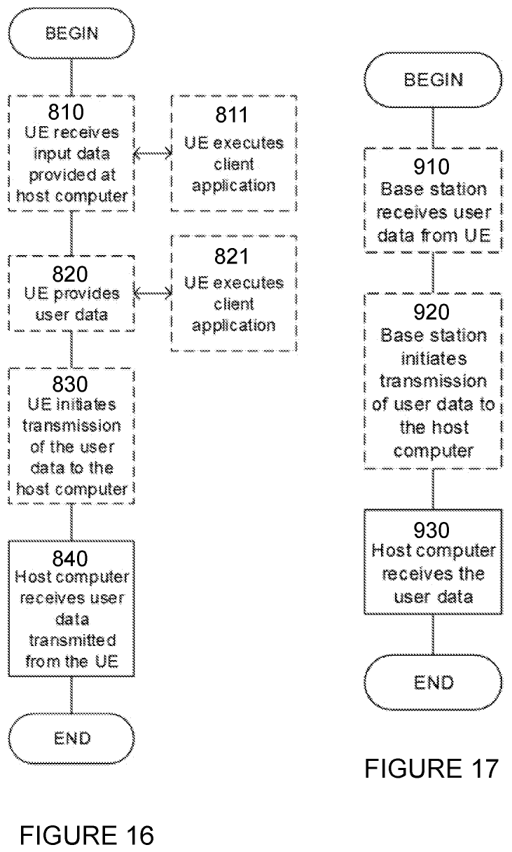

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

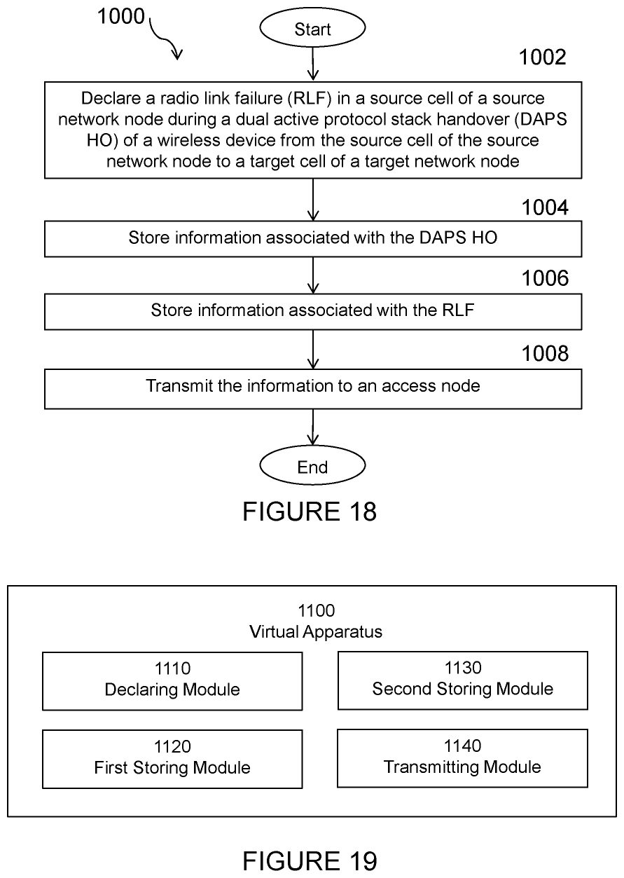

FIG. 18 depicts a method 1000 by a wireless device 110, according to certain embodiments. At step 1002, the wireless device declares a RLF in a source cell of a source network node during a DAPS HO from the source cell of the source network node to a target cell of a target network node. At step 1004, the wireless device stores information associated with the DAPS HO. At step 1006, the wireless device stores information associated with the RLF. At step 1008, the wireless device transmits the information to an access node.

In a particular embodiment, at least a portion of the information is transmitted in a RLF report or a handover report.

In a particular embodiment, the wireless device 110 transmits, to the access node, an indication of the availability of the information and receives a request to transmit the information. The information is transmitted in response to the request.

In a particular embodiment, the RLF is associated with a failed connection between the wireless device 110 and the source cell of the source network node.

In a particular embodiment, prior to declaring the RLF in the source cell of the source network node and during the DAPS HO of the wireless device, the wireless device 110 determines a handover failure and performs a fallback to the source cell of the source network node. The RLF is declared prior to successfully transmitting a handover failure message to the source network node.

As used herein, a handover is considered ongoing while timer T304 is running or until a failure is declared. Thus, as used herein, handover happens between a time when the UE gets the HO command and the time the UE sends the RRCReconfigurationComplete message to the target network node.

As used herein, the term fallback and the procedure for falling back refers to the wireless device returning to a source cell configuration and resuming the connection with source cell.

In a particular embodiment, the access node comprises a network node 160 with which the wireless device 110 establishes a connection after the wireless device 110 declares the radio link failure with the source network node.

In a particular embodiment, prior to transmitting the information, the wireless device 110 establishes a connection with the access node.

In a particular embodiment, the RLF is associated with a failed connection between the wireless device 110 and the target network node 160.

In a particular embodiment, in response to a successful DAPS HO of the wireless device 110 to the target cell associated with the target node, the wireless device 110 prepares a handover message indicating the successful DAPS HO of the wireless device 110 to the target network node. The RLF is declared prior to successfully transmitting the handover message indicating the successful DAPS HO of the wireless device 110 to the target network node.

In a further particular embodiment, the access node comprises the source network node.

In a particular embodiment, the wireless device 110 receives a handover command from the source network node and initiates the DAPS HO in response to the handover command.

In a particular embodiment, the information comprises a time between declaring a handover failure and declaring the RLF.

In a particular embodiment, the information comprises at least one of: radio measurements of the source cell of the dual active protocol stack handover; radio measurements of a target cell of the dual active protocol stack handover; radio measurements of at least one neighboring cell; a time between sending a RRCReconfigurationComplete message to the target node and declaring the RLF; and a status of a timer when a HO command was received from the source network node.

In a particular embodiment, the information comprises at least one of: an indication that the dual active protocol stack handover was not successful although the radio link failure was declared in the target cell of the dual active protocol stack handover; an indication that there was a lack of reception of a source release message from the target node; an indication that the wireless device was successful in sending a RRCReconfiguration Complete message to the target node of the target cell; and an indication regarding whether downlink data reception from the source network node was available at the time of declaring the radio link failure.

In various particular embodiments, the method may additionally or alternatively include one or more of the steps or features of the Group A1, Group A2, and Group C Example Embodiments described below.

FIG. 19 illustrates a schematic block diagram of a virtual apparatus 1100 in a wireless network (for example, the wireless network shown in FIG. 7). The apparatus may be implemented in a wireless device or network node (e.g., wireless device 110 or network node 160 shown in FIG. 7). Apparatus 1100 is operable to carry out the example method described with reference to FIG. 18 and possibly any other processes or methods disclosed herein. It is also to be understood that the method of FIG. 18 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause declaring module 1110, first storing module 1120, second storing module 1130, transmitting module 1140, and any other suitable units of apparatus 1100 to perform corresponding functions according one or more embodiments of the present disclosure.

According to certain embodiments, declaring module 1110 may perform certain of the declaring functions of the apparatus 1100. For example, declaring module 1110 may declare a RLF in a source cell of a source network node during a DAPS HO from the source cell of the source network node to a target cell of a target network node.

According to certain embodiments, first storing module 1120 may perform certain of the storing functions of the apparatus 1100. For example, first storing module 1120 may store information associated with the DAPS HO.

According to certain embodiments, second storing module 1120 may perform certain of the storing functions of the apparatus 1100. For example, storing module 1120 may store information associated with the RLF.

According to certain embodiments, transmitting module 1140 may perform certain of the transmitting functions of the apparatus 1100. For example, transmitting module 1140 may transmit the information to an access node.

Optionally, in particular embodiments, virtual apparatus may additionally include one or more modules for performing any of the steps or providing any of the features in the Group A1, Group A2, and Group C Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

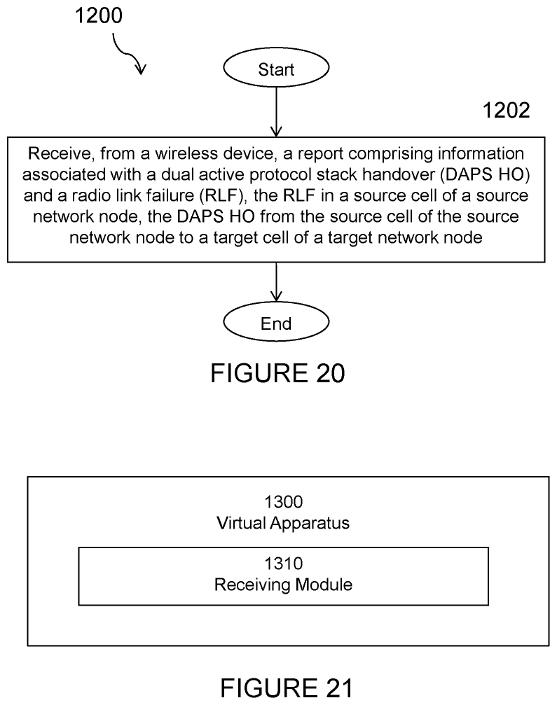

FIG. 20 depicts a method 1200 by a network node 160, according to certain embodiments. At step 1202, the network node 160 receives, from a wireless device, information associated with a DAPS HO and a RLF. The RLF is in a source cell of a source network node, and the DAPS HO is from the source cell of the source network node to a target cell of a target network node.

In a particular embodiment, at least a portion of the information is received in a RLF report or a handover report.

In a particular embodiment, prior to receiving the information, the network node 160 receives an indication of the availability of the information and transmits, to the wireless device 110, a request for the information.

In a particular embodiment, the network node 160 establishes a connection with the wireless device 110 after the wireless device 110 declares the RLF with the source cell of the source network node.

In a particular embodiment, the information indicates that a fallback to the source cell of the source network node has failed.

In a particular embodiment, the information indicates that the DAPS HO with the target cell of the target network node has failed.

In a particular embodiment, based on the information, the network node 160 determines at least one reason for failure of the DAPS HO.

In a particular embodiment, the network node transmits the information to the source network node.

In a particular embodiment, the network node 160 tunes or optimizes at least one handover parameter based on the information.

In a particular embodiment, the first network node comprises the source network node, the information indicates a successful handover with the target cell of the target network node, and the RLF is associated with a failed connection between the wireless device and the target cell of the target network node.

In a particular embodiment, the information comprises a time between declaring a handover failure and declaring the radio link failure.

In a particular embodiment, the information comprises at least one of: radio measurements of a source cell of the DAPS HO; radio measurements of a target cell of the DAPS HO; radio measurements of at least one neighboring cell; a time between sending a Radio Resource Control Reconfiguration Complete message to the target node and declaring the RLF; and a status of a timer when a handover command was received from the source network node.

In various particular embodiments, the method may include one or more of any of the steps or features of the Group B1, Group B2, Group B3, and Group C Example Embodiments described below.

FIG. 21 illustrates a schematic block diagram of a virtual apparatus 1300 in a wireless network (for example, the wireless network shown in FIG. 7). The apparatus may be implemented in a wireless device or network node (e.g., wireless device 110 or network node 160 shown in FIG. 7). Apparatus 1300 is operable to carry out the example method described with reference to FIG. 20 and possibly any other processes or methods disclosed herein. It is also to be understood that the method of FIG. 20 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310 and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a wireless device 110, information associated with a DAPS HO and a RLF. The RLF is in a source cell of a source network node, and the DAPS HO is from the source cell of the source network node to a target cell of a target network node.

Optionally, in particular embodiments, virtual apparatus may additionally include one or more modules for performing any of the steps or providing any of the features in the Group B1, Group B2, Group B3, and Group C Example Embodiments described below.

### EXAMPLE EMBODIMENTS

### Group A1 Embodiments

Example Embodiment 1. A method performed by a wireless device, the method comprising: during a handover (HO) of the wireless device, determining a HO failure and performing a fallback to the source node and/or source cell; prior to successfully transmitting the HO failure message to the source network node, the HO failure message comprising one or more measurements associated with the HO; declaring a radio link failure (RLF); generating an RLF report that comprises the one or more measurements associated with the HO; and transmitting the RLF report to an access node.

Example Embodiment 2. The method of Embodiment 1, wherein the type of HO is a dual active protocol stack handover.

Example Embodiment 3. The method of any one of Embodiments 1 to 2, further comprising transmitting the HO failure message, the HO failure message comprising the one or more measurements associated with the HO failure.

Example Embodiment 4. The method of any one of Embodiments 1 to 3, further comprising receiving a HO command from the network node and initiating the HO in response to the HO command.

Example Embodiment 5. The method of any one of Embodiments 1 to 4, wherein the one or more measurements associated with the HO comprise at least one of: radio measurements of a source cell of the HO; radio measurements of a target cell of the HO; radio measurements of at least one neighboring cell; a time between declaring the HO failure and declaring the radio link failure; and a status of a timer when a HO command was received from the network.

Example Embodiment 6. The method of any one of Embodiments 1 to 5, further comprising: prior to transmitting the RLF report, re-establishing a connection with the source node; transmitting, to the source node, an indication of the availability of the RLF report; and receiving a request to transmit the RLF report, wherein the RLF report is transmitted in response to the request.

Example Embodiment 7. The method of any one of Embodiments 1 to 6, wherein the access node is the source node.

Example Embodiment 8. A computer program comprising instructions which when executed on a computer perform any of the methods of embodiments 1 to 7.

Example Embodiment 9. A computer program product comprising computer program, the computer program comprising instructions which when executed on a computer perform any of the methods of embodiments 1 to 7.

Example Embodiment 10. A non-transitory computer readable medium storing instructions which when executed by a computer perform any of the methods of embodiments 1 to 7.

Example Embodiment 11. A wireless device comprising processing circuitry configured to perform any of the methods of embodiments 1 to 7.

### Group A2 Embodiments

Example Embodiment 12. A method performed by a wireless device, the method comprising: in response to a successful handover (HO) of the wireless device to a target cell, preparing a HO message indicating the successful HO of the wireless device to a target cell, the HO message comprising one or more measurements associated with the HO; prior to sending the HO message and before receiving a source release message, declaring a radio link failure (RLF); generating an RLF report that comprises the one or more measurements associated with the HO message; and transmitting the RLF report.

Example Embodiment 13. The method of Embodiment 12, wherein the type of HO is a dual active protocol stack handover.

Example Embodiment 14. The method of any one of Embodiments 12 to 13, further comprising transmitting the HO failure message, the HO failure message comprising the one or more measurements associated with the HO failure.

Example Embodiment 15. The method of any one of Embodiments 12 to 14, further comprising receiving a HO command and initiating the HO in response to the HO command.

Example Embodiment 16. The method of any one of Embodiments 12 to 15, wherein the one or more measurements associated with the HO comprise at least one of: radio measurements of a source cell of the HO; radio measurements of a target cell of the HO; radio measurements of at least one neighboring cell; a time between declaring the HO failure and declaring the radio link failure; a time between sending a RRCReconfigurationComplete message to the target node and declaring the RLF; and a status of a timer when a HO command was received from the network.

Example Embodiment 17. The method of any one of Embodiments 12 to 16, wherein the RLF report comprises at least one of: an indication that the HO was not successful although the RLF was declared in the target cell of the HO; an indication that there was a lack of reception of a source release message from the target node; an indication that the wireless device was successful in sending a RRCReconfiguration Complete message to the target node of the target cell; and an indication regarding whether downlink data reception from the source was available at the time of declaring the RLF.

Example Embodiment 18. The method of any one of Embodiments 12 to 17, further comprising: prior to transmitting the RLF report, re-establishing a connection with the source node; transmitting, to the source node, an indication of the availability of the RLF rep ort; and receiving a request to transmit the RLF report, wherein the RLF report is transmitted in response to the request.

Example Embodiment 19. A computer program comprising instructions which when executed on a computer perform any of the methods of embodiments 12 to 18.

Example Embodiment 20. A computer program product comprising computer program, the computer program comprising instructions which when executed on a computer perform any of the methods of embodiments 12 to 18.

Example Embodiment 21. A non-transitory computer readable medium storing instructions which when executed by a computer perform any of the methods of embodiments 12 to 18.

Example Embodiment 22. A wireless device comprising processing circuitry configured to perform any of the methods of embodiments 12 to 18.

### Group B1 Embodiments

Example Embodiment 23. A method performed by a network node operating as a source network during a handover (HO) of a wireless device from the source network node to a target network node, the method comprising: receiving, from the wireless device that performed a fallback to the source network node during the HO, a radio link failure (RLF) report, the RLF report comprising one or more measurements associated with the HO failure.

Example Embodiment 24. The method of Embodiment 23, wherein the type of handover is a dual active protocol stack handover.

Example Embodiment 25. The method of any one of Embodiments 23 to 24, wherein the RLF report is not a handover failure message indicating a failure of the handover.

Example Embodiment 26. The method of any one of Embodiments 23 to 25, further comprising receiving the HO failure message, the HO failure message comprising the one or more measurements associated with the HO failure.

Example Embodiment 27. The method of any one of Embodiments 23 to 26, further comprising transmitting, to the wireless device, a HO command, wherein the HO is initiated by the wireless device in response to the HO command.

Example Embodiment 28. The method of any one of Embodiments 23 to 27, wherein the one or more measurements associated with the HO comprise at least one of: radio measurements of a source cell of the HO; radio measurements of a target cell of the HO; radio measurements of at least one neighboring cell; a time between declaring the HO failure and declaring the radio link failure; and a status of a timer when a HO command was received from the network.

Example Embodiment 29. The method of any one of Embodiments 23 to 28, further comprising: prior to receiving the RLF report, re-establishing a connection between the source node and the wireless device; receiving, from the wireless device, an indication of the availability of the RLF report; and transmitting, to the wireless device, a request to transmit the RLF report.

Example Embodiment 30. The method of any one of Embodiments 23 to 29, further comprising transmitting the RLF report to the target node associated with the HO.

Example Embodiment 31. The method of Embodiment 30, wherein the target node is identified in the RLF report.

Example Embodiment 32. The method of any one of Embodiments 23 to 31, further comprising determining, based on the RLF report, at least one reason for the HO failure.

Example Embodiment 33. The method of any one of Embodiments 23 to 32, further comprising tuning and/or optimizing at least one HO parameter based on the RLF report.

Example Embodiment 34. A computer program comprising instructions which when executed on a computer perform any of the methods of embodiments 23 to 33.

Example Embodiment 35. A computer program product comprising computer program, the computer program comprising instructions which when executed on a computer perform any of the methods of embodiments 23 to 33.

Example Embodiment 36. A non-transitory computer readable medium storing instructions which when executed by a computer perform any of the methods of embodiments 23 to 33.

Example Embodiment 37. A network node comprising processing circuitry configured to perform any of the methods of embodiments 23 to 33.

### Group B2 Embodiments

Example Embodiment 38. A method performed by a network node operating as a source network during a handover (HO) of a wireless device from the source network node to a target network node, the method comprising: receiving, from the wireless device, a radio link failure (RLF) report, the RLF report comprising one or more measurements associated with the HO of the wireless device to a target node.

Example Embodiment 39. The method of Embodiment 38, wherein the HO is a dual active protocol stack handover.

Example Embodiment 40. The method of any one of Embodiments 38 to 39, further comprising transmitting a HO command to the wireless device.

Example Embodiment 41. The method of any one of Embodiments 38 to 40, wherein the one or more measurements associated with the HO comprise at least one of: radio measurements of a source cell of the HO; radio measurements of a target cell of the HO; radio measurements of at least one neighboring cell; a time between declaring the HO failure and declaring the radio link failure; and a status of a timer when a HO command was received from the network.

Example Embodiment 42. The method of any one of Embodiments 38 to 41, further comprising: prior to receiving the RLF report, re-establishing a connection between the source node and the wireless device; receiving, from the wireless device, an indication of the availability of the RLF report; transmitting, to the wireless device, a request to transmit the RLF report.

Example Embodiment 43. The method of any one of Embodiments 38 to 42, further comprising transmitting the RLF report to the target node associated with the HO.

Example Embodiment 44. The method of Embodiment 43 wherein the target node is identified in the RLF report.

Example Embodiment 45. The method of any one of Embodiments 38 to 44, further comprising tuning and/or optimizing at least one HO parameter based on the RLF report.

Example Embodiment 46. A computer program comprising instructions which when executed on a computer perform any of the methods of embodiments 38 to 45.

Example Embodiment 47. A computer program product comprising computer program, the computer program comprising instructions which when executed on a computer perform any of the methods of embodiments 38 to 45.

Example Embodiment 48. A non-transitory computer readable medium storing instructions which when executed by a computer perform any of the methods of embodiments 38 to 45.

Example Embodiment 49. A network node comprising processing circuitry configured to perform any of the methods of embodiments 38 to 45.

### Group B3 Embodiments

Example Embodiment 50. A method performed by a network node operating as a target network during a handover (HO) of a wireless device from a source network node to the target network node, the method comprising: receiving, from a node, a radio link failure (RLF) report, the RLF report comprising one or more measurements associated with the HO of the wireless device to the target node; and performing at least one action based on the one or more measurements associated.

Example Embodiment 51. The method of Embodiment 50, wherein the HO is a dual active protocol stack handover.

Example Embodiment 52. The method of any one of Embodiments 50 to 51, wherein the one or more measurements associated with the HO comprise at least one of: radio measurements of a source cell of the HO; radio measurements of a target cell of the HO; radio measurements of at least one neighboring cell; a time between declaring the HO failure and declaring the radio link failure; and a status of a timer when a HO command was received from the network.

Example Embodiment 53. The method of any one of Embodiments 50 to 52, wherein the node comprises a node having established a reconnection with the wireless device after a radio link failure (RLF).

Example Embodiment 54. The method of any one of Embodiments 50 to 53, wherein the node is the source node.

Example Embodiment 55. The method of any one of Embodiments 50 to 54, further comprising determining, based on the one or more measurements, whether a cause of the failure is a source node and/or source cell or a target node and/or target cell.

Example Embodiment 56. The method of any one of Embodiments 50 to 55, further comprising transmitting the RLF report to the source node associated with the HO.

Example Embodiment 57. A computer program comprising instructions which when executed on a computer perform any of the methods of embodiments 50 to 56.

Example Embodiment 58. A computer program product comprising computer program, the computer program comprising instructions which when executed on a computer perform any of the methods of embodiments 50 to 56.

Example Embodiment 59. A non-transitory computer readable medium storing instructions which when executed by a computer perform any of the methods of embodiments 50 to 56.

Example Embodiment 60. A network node comprising processing circuitry configured to perform any of the methods of embodiments 50 to 56.

### Group C Embodiments

Example Embodiment 61. A wireless device comprising: processing circuitry configured to perform any of the steps of any of the Group A1 and A2 embodiments; and power supply circuitry configured to supply power to the wireless device.

Example Embodiment 62. A network node comprising: processing circuitry configured to perform any of the steps of any of the Group B1, B2, and B3 embodiments; power supply circuitry configured to supply power to the wireless device.

Example Embodiment 63. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A1 and A2 embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment 64. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B1, B2, and B3 embodiments.

Example Embodiment 65. The communication system of the pervious embodiment further including the network node.

Example Embodiment 66. The communication system of the previous 2 embodiments, further including the wireless device, wherein the wireless device is configured to communicate with the network node.

Example Embodiment 67. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment 68. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B1, B2, and B3 embodiments.

Example Embodiment 69. The method of the previous embodiment, further comprising, at the network node, transmitting the user data.

Example Embodiment 70. The method of the previous 2 embodiments, wherein the user data is provided at the host computer by executing a host application, the method further comprising, at the wireless device, executing a client application associated with the host application.

Example Embodiment 71. A wireless device configured to communicate with a network node, the wireless device comprising a radio interface and processing circuitry configured to performs the of the previous 3 embodiments.

Example Embodiment 72. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A1 and A2 embodiments.

Example Embodiment 73. The communication system of the previous embodiment, wherein the cellular network further includes a network node configured to communicate with the wireless device.

Example Embodiment 74. The communication system of the previous 2 embodiments, wherein: the processing circuitry of the host computer is configured to execute a host application, thereby providing the user data; and the wireless device's processing circuitry is configured to execute a client application associated with the host application.

Example Embodiment 75. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A1 and A2 embodiments.

Example Embodiment 76. The method of the previous embodiment, further comprising at the wireless device, receiving the user data from the network node.

Example Embodiment 77. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A1 and A2 embodiments.

Example Embodiment 78. The communication system of the previous embodiment, further including the wireless device.

Example Embodiment 79. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment 80. The communication system of the previous 3 embodiments, wherein: the processing circuitry of the host computer is configured to execute a host application; and the wireless device's processing circuitry is configured to execute a client application associated with the host application, thereby providing the user data.

Example Embodiment 81. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment 82. A method implemented in a communication system including a host computer, a network node and a wireless device, the method comprising: at the host computer, receiving user data transmitted to the network node from the wireless device, wherein the wireless device performs any of the steps of any of the Group A1 and A2 embodiments.

Example Embodiment 83. The method of the previous embodiment, further comprising, at the wireless device, providing the user data to the network node.

Example Embodiment 84. The method of the previous 2 embodiments, further comprising: at the wireless device, executing a client application, thereby providing the user data to be transmitted; and at the host computer, executing a host application associated with the client application.

Example Embodiment 85. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment 86. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B1, B2, and B3 embodiments.

Example Embodiment 87. The communication system of the previous embodiment further including the network node.

Example Embodiment 88. The communication system of the previous 2 embodiments, further including the wireless device, wherein the wireless device is configured to communicate with the network node.

Example Embodiment 89. The communication system of the previous 3 embodiments, wherein: the processing circuitry of the host computer is configured to execute a host application; the wireless device is configured to execute a client application associated with the host application, thereby providing the user data to be received by the host computer.

Example Embodiment 90. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A embodiments.

Example Embodiment 91. The method of the previous embodiment, further comprising at the network node receiving the user data from the wireless device.

Example Embodiment 92. The method of the previous 2 embodiments, further comprising at the network node, initiating a transmission of the received user data to the host computer.

Example Embodiment 93. The method of any of the previous embodiments, wherein the network node comprises a base station.

Example Embodiment 94. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1.-34. (canceled)

35. A method performed by a wireless device, the method comprising:
declaring a radio link failure in a source cell of a source network node, during a dual active protocol stack, DAPS, handover from the source cell of the source network node to a target cell of a target network node;
declaring a DAPS handover failure;
storing information associated with the DAPS handover;
storing information associated with the radio link failure; and
transmitting the information in a radio link failure report to an access node.

36. The method of claim 35, further comprising:
transmitting, to the access node, an indication of the availability of the information; and
receiving a request to transmit the information, wherein the information is transmitted in response to the request.

37. The method of claim 35, wherein the radio link failure is associated with a failed connection between the wireless device and the source cell of the source network node.

38. The method of claim 35, wherein the access node comprises a network node with which the wireless device establishes a connection after the wireless device declares the radio link failure with the source network node.

39. The method of claim 38, further comprising prior to transmitting the information, establishing a connection with the access node.

40. The method of claim 35, further comprising receiving a handover command from the source network node and initiating the dual active protocol stack handover in response to the handover command.

41. The method of claim 35, wherein the information comprises a time between declaring a handover failure and declaring the radio link failure.

42. The method of claim 35, wherein the information comprises at least one of:
radio measurements of the source cell of the dual active protocol stack handover;
radio measurements of a target cell of the dual active protocol stack handover;
radio measurements of at least one neighboring cell;
a time between sending a RRCReconfigurationComplete message to the target node and declaring the RLF; and
a status of a timer when a HO command was received from the source network node.

43. The method of claim 40, wherein the information comprises a time elapsed between reception of DAPS handover command and radio link failure in the source cell.

44. A method performed by a network node comprising:
receiving, in a radio link failure report from a wireless device, information associated with a dual active protocol stack handover and a radio link failure, wherein the radio link failure is in a source cell of a source network node, wherein the dual active protocol stack handover is from the source cell of the source network node to a target cell of a target network node.

45. The method of claim 44, further comprising:
prior to receiving the information, receiving an indication of the availability of the information; and
transmitting, to the wireless device, a request for the information.

46. The method of claim 44, wherein the network node establishes a connection with the wireless device after the wireless device declares the radio link failure with the source cell of the source network node.

47. The method of claim 46, wherein the information indicates that the dual active protocol stack handover with the target cell of the target network node has failed.

48. The method of claim 47, further comprising tuning or optimizing at least one handover parameter based on the information.

49. The method of claim 44, wherein the information comprises a time between declaring a handover failure and declaring the radio link failure.

50. The method of claim 44, wherein the information comprises at least one of:
radio measurements of a source cell of the dual active protocol stack handover;
radio measurements of a target cell of the dual active protocol stack handover;
radio measurements of at least one neighboring cell;
a time between sending a Radio Resource Control Reconfiguration Complete message to the target node and declaring the radio link failure; and
a status of a timer when a handover command was received from the source network node.

51. The method of claim 44, wherein the information comprises a time elapsed between reception of DAPS handover command and radio link failure in the source cell.

52. A wireless device adapted to:
declare a radio link failure in the source cell of a source network node, during a dual active protocol stack, DAPS, handover from the source cell of the source network node to a target cell of a target network node;
declare a DAPS handover failure:
store information associated with the dual active protocol stack, DAPS, handover;
store information associated with the radio link failure; and
transmit the information in a radio link failure report to an access node.

53. A wireless device comprising:
processing circuitry configured to:
declare a radio link failure in the source cell of a source network node, during a dual active protocol stack, DAPS, handover from the source cell of the source network node to a target cell of a target network node;
declare a DAPS handover failure;
store information associated with the dual active protocol stack, DAPS, handover;
store information associated with the radio link failure; and
transmit the information in a radio link failure report to an access node.

54. A first network node adapted to:
receive, in a radio link failure report from a wireless device, information associated with a dual active protocol stack handover and a radio link failure, wherein the radio link failure is in a source cell of a source network node, wherein the dual active protocol stack handover is from the source cell of the source network node to a target cell of a target network node.

55. A first network node comprising:
processing circuitry configured to:
receive, in a radio link failure report from a wireless device, information associated with a dual active protocol stack handover and a radio link failure, wherein the radio link failure is in a source cell of a source network node, wherein the dual active protocol stack handover is from the source cell of the source network node to a target cell of a target network node.
